(19) United States
(12) Patent Application Publication
(10) Pub. No.: US 2026/0018802 A1
(43) Pub. Date: Jan. 15, 2026

(54) ANTENNA DEVICE AND METHOD FOR CONFIGURING ANTENNA DEVICE

(71) Applicant: Gemtek Technology Co., Ltd., Hsinchu (TW)

(72) Inventors: Hsiao-Ching Chien, Hsinchu (TW); Hsu-Sheng Wu, Hsinchu (TW)

(73) Assignee: Gemtek Technology Co., Ltd., Hsinchu (TW)

(21) Appl. No.: 19/070,485

(22) Filed: Mar. 4, 2025

Related U.S. Application Data
(60) Provisional application No. 63/669,208, filed on Jul. 9, 2024.

(30) Foreign Application Priority Data
Nov. 19, 2024 (TW) 113212610

(51) Int. Cl. H01Q 19/19; H01Q 19/06; H01Q 19/10

(52) U.S. Cl. CPC H01Q 19/19; H01Q 19/06; H01Q 19/10

(57) ABSTRACT

An antenna device and a method for configuring an antenna device are provided. The antenna device includes a phased array antenna and a wave-shaping accessory. The phased array antenna transmits a radio frequency signal. The wave-shaping accessory is configured to reflect or refract the radio frequency signal to form a beam.

### CROSS-REFERENCE TO RELATED APPLICATION

This application claims the priority benefit of U.S. Provisional Application No. 63/669,208, filed on Jul. 9, 2024 and Taiwan Application No. 113212610, filed on Nov. 19, 2024. The entirety of each of the above-mentioned patent applications is hereby incorporated by reference herein and made a part of this specification.

### BACKGROUND

### Technical Field

The disclosure relates to a wireless communication technology, and in particular to an antenna device and a method for configuring an antenna device.

### Related Art

A parabolic antenna or a lens antenna are common antenna devices. The antenna devices may effectively concentrate energy of radio frequency signals to deliver the radio frequency signals to distant terminal devices. However, traditional methods may not flexibly adjust the amplitude or phase of the antenna devices, thereby making the antenna devices unsuitable for beam shaping-based wireless communication systems.

### SUMMARY

The disclosure provides a method for configuring an antenna device and an antenna device which may be configured to become a parabolic antenna or lens antenna with a beam shaping function.

An antenna device of the disclosure includes a phased array antenna and a wave-shaping accessory. The phased array antenna emits a radio frequency signal. The wave-shaping accessory is configured to reflect or refract the radio frequency signal to form a beam.

In an embodiment of the disclosure, the aforementioned wave-shaping accessory includes at least one reflector.

In an embodiment of the disclosure, the aforementioned antenna device includes a parabolic antenna, and the at least one reflector includes a main reflector and a sub-reflector. The sub-reflector reflects the radio frequency signal to the main reflector, where the main reflector reflects the radio frequency signal to form a beam.

In an embodiment of the disclosure, the aforementioned wave-shaping accessory includes a lens.

In an embodiment of the disclosure, the material of the aforementioned lens includes a dielectric material.

In an embodiment of the disclosure, the aforementioned antenna device further includes a receiver and a controller. The receiver is coupled to the phased array antenna and receives feedback information. The controller is coupled to the phased array antenna and the receiver, where the controller adjusts an amplitude or a phase of output of an antenna unit of the phased array antenna according to the feedback information.

In an embodiment of the disclosure, the aforementioned radio frequency signal forms one of a first beam-forming signal and a second beam-forming signal, where the feedback information indicates one of the first beam-forming signal and the second beam-forming signal.

In an embodiment of the disclosure, the aforementioned feedback information further indicates a measurement result of the radio frequency signal of a terminal device, where the controller adjusts the output of the antenna unit according to the measurement result.

In an embodiment of the disclosure, the aforementioned phased array antenna includes one of a monopole antenna, a dipole antenna, and a multi-polarized antenna.

A method for configuring an antenna device, including: configuring a phased array antenna of the antenna device to emit a radio frequency signal; and configuring a wave-shaping accessory of the antenna device to reflect or refract the radio frequency signal to form a beam.

In one embodiment of the disclosure, the aforementioned wave-shaping accessory includes at least one reflector.

In one embodiment of the disclosure, the aforementioned antenna device includes a parabolic antenna, and the at least one reflector includes a main reflector and a sub-reflector, wherein the step of configuring the wave-shaping accessory of the antenna device to reflect or refract the radio frequency signal to form the beam includes: configuring the sub-reflector to reflect the radio frequency signal to the main reflector; and configuring the main reflector to reflect the radio frequency signal to form the beam.

In one embodiment of the disclosure, the aforementioned wave-shaping accessory includes a lens.

In one embodiment of the disclosure, a material of the lens includes a dielectric material.

In one embodiment of the disclosure, the aforementioned method further including: configuring a receiver of the antenna device to couple to the phased array antenna and receive feedback information; and adjusting an amplitude or a phase of output of an antenna unit of the phased array antenna according to the feedback information.

In one embodiment of the disclosure, the aforementioned radio frequency signal forms one of a first beam-forming signal and a second beam-forming signal, wherein the feedback information indicates the one of the first beam-forming signal and the second beam-forming signal.

In one embodiment of the disclosure, the aforementioned feedback information further indicates a measurement result of the radio frequency signal of a terminal device, wherein the method further includes: adjusting the output of the antenna unit according to the measurement result.

In one embodiment of the disclosure, the aforementioned phased array antenna includes one of a monopole antenna, dipole antenna, and a multi-polarized antenna.

Based on the above, the antenna device of the disclosure may combine the phased array antenna and the wave-shaping accessory to generate a parabolic antenna or lens antenna with a beam shaping function.

### BRIEF DESCRIPTION OF THE DRAWINGS

FIG. 1 illustrates a schematic view of an antenna device according to an embodiment of the disclosure.

FIG. 2 illustrates a schematic view of a phased array antenna according to an embodiment of the disclosure.

FIG. 3 illustrates a schematic view of a parabolic antenna according to an embodiment of the disclosure.

FIG. 4 illustrates a perspective view of a lens antenna according to an embodiment of the disclosure.

FIG. 5 illustrates a front view of a lens antenna according to an embodiment of the disclosure.

FIG. 6 illustrates a flowchart of a method for transmission power management according to an embodiment of the disclosure.

FIG. 7 illustrates a schematic diagram of a beam gain according to an embodiment of the disclosure.

FIG. 8 illustrates a flowchart of a method for configuring an antenna device according to an embodiment of the disclosure.

### DESCRIPTION OF THE EMBODIMENTS

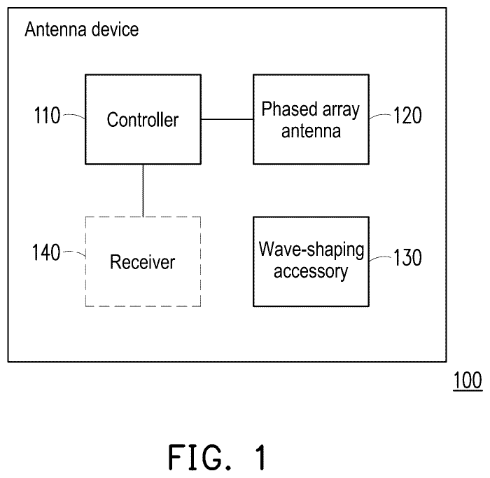

FIG. 1 illustrates a schematic view of an antenna device according to an embodiment of the disclosure. An antenna device 100 may include a controller 110, a phased array antenna 120, a wave-shaping accessory 130, and a receiver 140. The controller 110 may be coupled to the phased array antenna 120 and the receiver 140. The phased array antenna 120 and the receiver 140 may be the same or different elements. For example, the phased array antenna 120 may transmit a radio frequency signal, and may serve as the receiver 140 to receive the radio frequency signal.

The controller 110 may include a processor and a transceiver coupled to the processor. The processor may be, for example, a central processing unit (CPU), a micro control unit (MCU) for a common purpose or a specific purpose, a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable gate array (FPGA), other similar elements, or a combination thereof. The transceiver may transmit or receive signals. In addition, the transceiver may further perform operations such as low noise amplification, impedance matching, frequency mixing, up or down frequency conversion, filtering, or amplification.

The receiver 140 may receive signals. In addition, the receiver 140 may further perform operations such as low noise amplification, impedance matching, frequency mixing, up or down frequency conversion, filtering, or amplification. In an embodiment, the receiver 140 and the phased array antenna 120 may be the same element. In another embodiment, the receiver 140 may be coupled to the phased array antenna 120 through the controller 110.

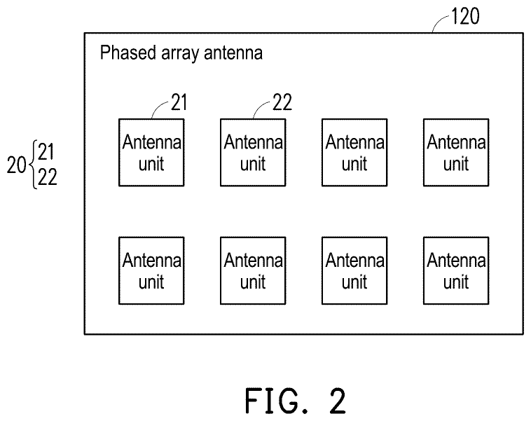

The phased array antenna 120 may include, but is not limited to, a monopole antenna, a dipole antenna, or a multi-polarized antenna. FIG. 2 illustrates a schematic view of the phased array antenna 120 according to an embodiment of the disclosure. The phased array antenna 120 may include one or multiple antenna units 20 (for example, an antenna unit 21 or an antenna unit 22). The controller 110 may emit a radio frequency signal via the phased array antenna 120, where the controller 110 may adjust an amplitude or a phase of the radio frequency signal output by the phased array antenna 120 through the following methods: enabling one or multiple antenna units 20, disabling one or more multiple units 20, allocating transmission rates for one or multiple antenna units 20, or allocating transmission power for one or multiple antenna units 20, but the disclosure is not limited to these methods.

The wave-shaping accessory 130 may be configured on a side of the phased array antenna 120 to reflect or refract a radio frequency signal output by the phased array antenna 120 to form a beam. The antenna device 100 may transmit a wireless signal to a terminal device or receive a wireless signal from the terminal device through the beam.

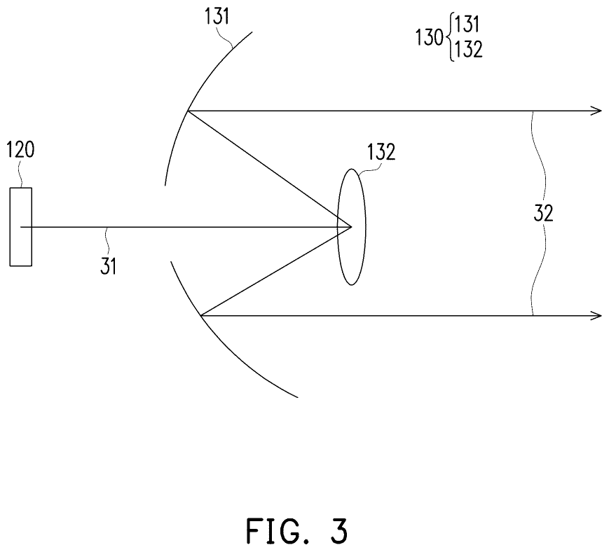

In an embodiment, the antenna device 100 may be a parabolic antenna, and the wave-shaping accessory 130 may include a reflector. FIG. 3 illustrates a schematic view of a parabolic antenna according to an embodiment of the disclosure. The wave-shaping accessory 130 of the antenna device 100 may include a main reflector 131 and a sub-reflector 132. The sub-reflector 132 may reflect a radio frequency signal 31 output by the phased array antenna 120 to the main reflector 131. The main reflector 131 may reflect the radio frequency signal 31 again to form a beam 32. The controller 110 may form beams transmitted in different directions by adjusting an amplitude or a phase of the radio frequency signal 31 output by the phased array antenna 120. For example, the sub-reflector 132 may be configured at the transmit direction of the radio frequency signal 31 outputted by the phased array antenna 120 to reflect the radio frequency signal 31. The main reflector 131 may be configured at the reflect path of the sub-reflector 132, and receive the radio frequency signal 31 from the sub-reflector 132 to reflect the radio frequency signal 31 again. In an embodiment, the phased array antenna 120 may be configured on the wave-shaping accessory 130. For example, the phased array antenna 120 may be configured on the main reflector 131.

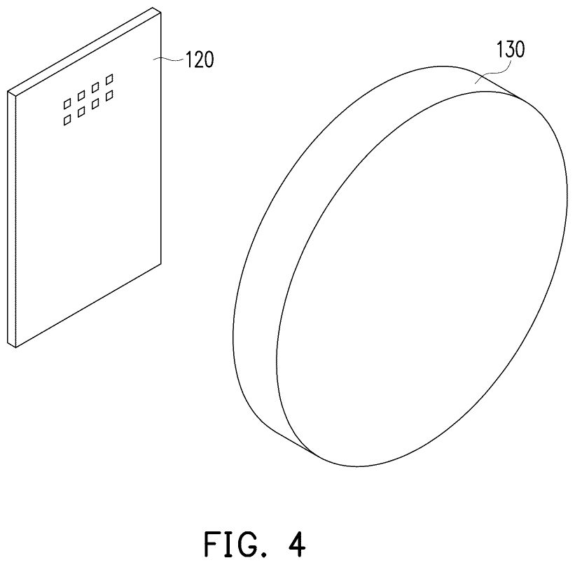

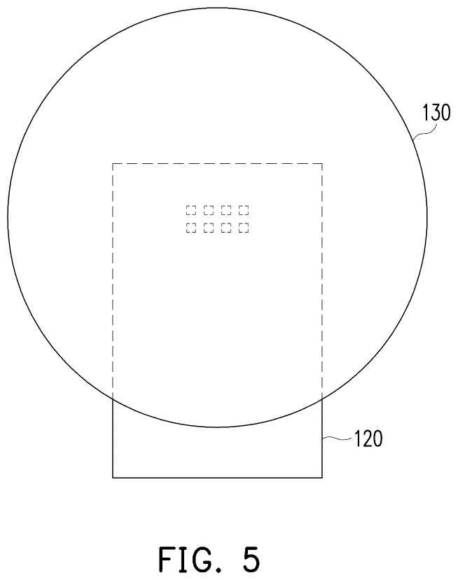

In an embodiment, the antenna device 100 may be a lens antenna, and the wave-shaping accessory 130 may be, for example, a lens, where a material of the lens may include a dielectric material. FIG. 4 illustrates a perspective view of a lens antenna according to an embodiment of the disclosure, and FIG. 5 illustrates a front view of a lens antenna according to an embodiment of the disclosure. The controller 110 may transmit a radio frequency signal to the wave-shaping accessory 130 via the phased array antenna 120. The wave-shaping accessory 130 may refract the radio frequency signal to form a beam. The controller 110 may form beams transmitted in different directions by adjusting the amplitude or phase of the radio frequency signal 31 output by the phased array antenna 120. For example, the lens antenna may be configured at the transmit direction of the radio frequency signal outputted by the phased array antenna 120 to refract the radio frequency signal 31.

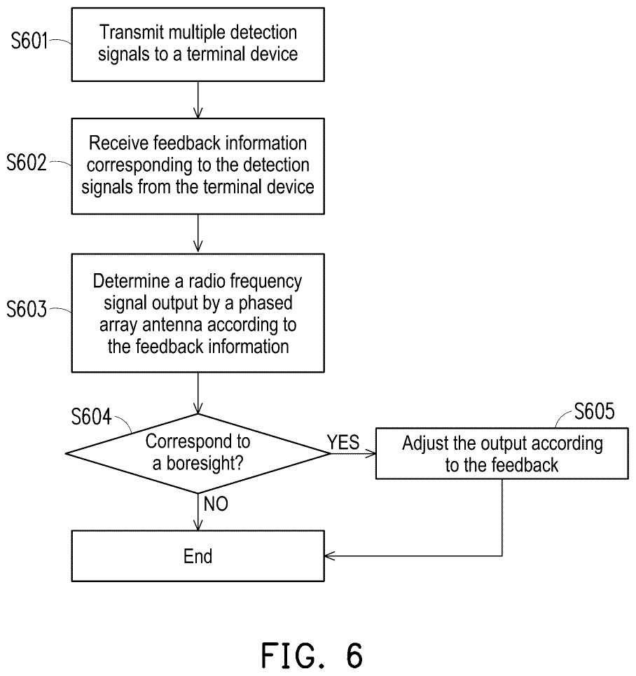

FIG. 6 illustrates a flowchart of a method for transmission power management according to an embodiment of the disclosure, where the method may be implemented by the antenna device 100 as shown in FIG. 1.

In step S601, the controller 110 may transmit multiple detection signals to the terminal device by using multiple beams respectively. Specifically, the controller 110 may form multiple different beams via the phased array antenna 120 and the wave-shaping accessory 130 and transmit the detection signals to the terminal device respectively by the different beams. The different beams mentioned above may correspond to multiple different beam identifications (IDs) respectively.

The terminal device may receive the detection signals and measure the detection signals respectively to generate a measurement result. The measurement result may include, but are not limited to, received signal strength indication (RSSI) or channel state information (CSI).

In an embodiment, feedback information may further indicate the measurement result of the detection signals by the terminal device. The controller 110 may adjust the amplitude or phase of the radio frequency signal output by the phased array antenna 120 according to the measurement result. For example, if the measurement result indicates that the detection signals received by the terminal device have a smaller RSSI, the controller 110 may amplify the amplitude of the output from the phased array antenna 120 to improve the RSSI of the terminal device.

In an embodiment, before transmitting the detection signals to the terminal device, the antenna device 100 may select one of the beams supported by the antenna device 100, and communicate with the terminal device through the selected beam to establish a communication channel between the antenna device 100 and the terminal device. For example, the antenna device 100 may communicate with the terminal device through the beam corresponding to beam identification X.

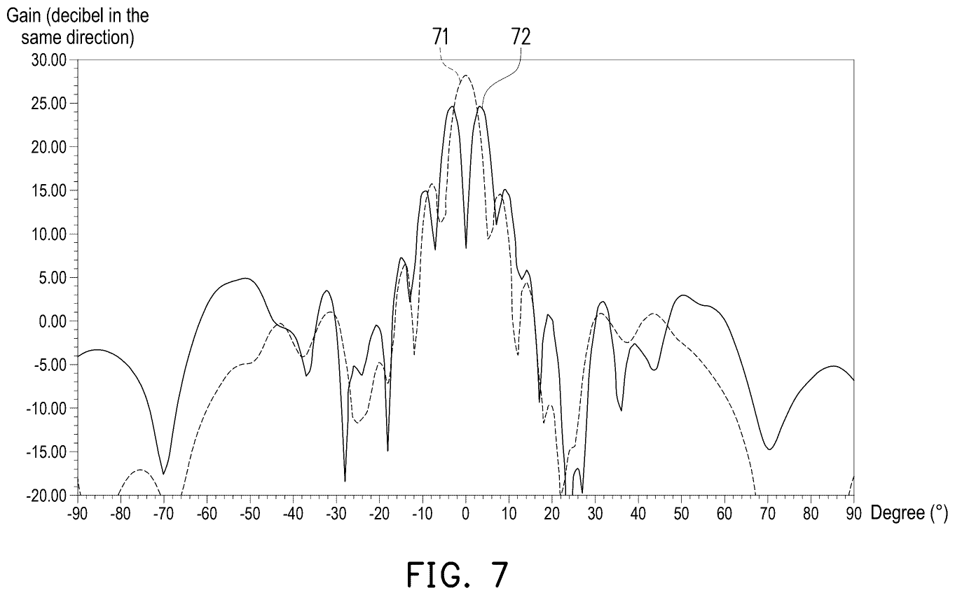

FIG. 7 illustrates a schematic diagram of beam gain according to an embodiment of the disclosure, where a curve 71 represents a gain corresponding to a beam #1, and a curve 72 represents a gain corresponding to a beam #2. Assuming that a main lobe direction (for example, a direction represented by 0 degrees) of the beam #1 is the same as a main lobe direction of the beam #2, and a gain of the beam #1 in the main lobe direction is greater than the gain of the beam #2 in the main lobe direction. When the terminal device, which serves as the receiver of the radio frequency signal, is located in the main lobe direction of the beam #1 or the beam #2 and a distance between the terminal device and the antenna device 100 is very close, using the beam #1 to transmit signals may result in reduced signal quality due to saturation of the amplifier in the terminal device. Therefore, the antenna device 100 may select the beam #2 from the supported beams #1 and #2 to communicate with the terminal device.

In step S602, the controller 110 may receive feedback information corresponding to the detection signals from the terminal device via the receiver 140. The feedback information may be configured to indicate one of the beams formed by the antenna device 100. For example, the feedback information may include beam identification, where the beam identification (for example, beam identification Y, where the beam identification Y may be the same as or different from the beam identification X) may be configured to indicate one of the beams which may be formed by the antenna device 100. In an embodiment, the beam identification may be configured to indicate the directionality of the beam formed by the antenna device 100.

In step S603, the controller 110 may determine the radio frequency signal output by the phased array antenna 120 according to the feedback information. Specifically, the controller 110 may adjust the amplitude or phase of the radio frequency signal output by the phased array antenna 120, so that after the radio frequency signal is reflected or refracted by the wave-shaping accessory 130, the controller 110 forms the beam indicated by the feedback information. The antenna device 100 may conduct data transmission with the terminal device through the beam.

In an embodiment, in addition to using the beam indicated by the feedback information for data transmission, the controller 110 may further conduct data transmission with the terminal device through other beams. The controller 110 may, in response to the feedback information indicating a specific beam, increase the usage time of the specific beam (that is, the time for conducting data transmission) and reduce the usage time of the other beams.

In step S604, the controller 110 may determine whether the beam formed by the antenna device 100 corresponds to a boresight of the phased array antenna 120 or the wave-shaping accessory 130 (for example, the direction of the beam is the same as a direction of the boresight), where the boresight is, for example, a straight line passing through a geometric center of the phased array antenna 120 or the wave-shaping accessory 130. Accordingly, in step S605, the controller 110 may adjust the output amplitude of the phased array antenna 120 (or the antenna unit 20) according to the feedback information. If the beam corresponds to the boresight, it represents that adjusting the output amplitude of the phased array antenna 120 (or antenna unit 20) has a less significant impact on the directionality of the beam. If the beam does not correspond to the boresight (for example, the direction of the beam is different from the direction of the boresight), it represents that adjusting the output amplitude of the phased array antenna 120 (or the antenna unit 20) has a more significant impact on the directionality of the beam. Accordingly, the controller 110 may not execute step S605 and end the process.

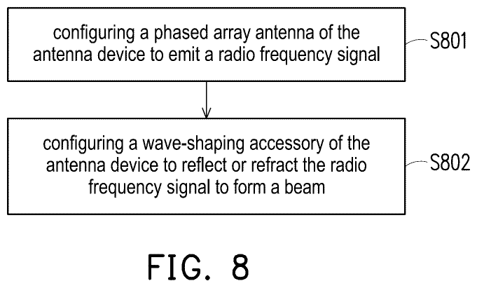

FIG. 8 illustrates a flowchart of a method for configuring an antenna device according to an embodiment of the disclosure. In step S801, configuring a phased array antenna of the antenna device to emit a radio frequency signal. In step S802, configuring a wave-shaping accessory of the antenna device to reflect or refract the radio frequency signal to form a beam.

In summary, the antenna device of the disclosure may combine the phased array antenna and the wave-shaping accessory to generate a parabolic antenna or lens antenna with a beam shaping function. The antenna device may output the radio frequency signal through the phased array antenna, and reflect or refract the radio frequency signal through the wave-shaping accessory to form the beam. The antenna device may form different beams by adjusting the amplitude or phase of the radio frequency signal, to conduct communication with the terminal device through various beams. To reduce the high power consumption caused by the use of a greater number of chips in a phased array antenna to achieve long transmission distances, the present may pair the phased array antenna with a wave-shaping accessory, thereby reducing chip usage and power consumption. Furthermore, the antenna device can implement a transmission power management method to enhance transmission efficiency.

What is claimed is:

1. An antenna device, comprising:
a phased array antenna, emitting a radio frequency signal; and
a wave-shaping accessory, configured to reflect or refract the radio frequency signal to form a beam.

2. The antenna device according to claim 1, wherein the wave-shaping accessory comprises at least one reflector.

3. The antenna device according to claim 2, wherein the antenna device comprises a parabolic antenna, and the at least one reflector comprises:
a main reflector; and
a sub-reflector, reflecting the radio frequency signal to the main reflector, wherein
the main reflector reflects the radio frequency signal to form the beam.

4. The antenna device according to claim 1, wherein the wave-shaping accessory comprises a lens.

5. The antenna device according to claim 4, wherein a material of the lens comprises a dielectric material.

6. The antenna device according to claim 1, further comprising:
a receiver, coupled to the phased array antenna and receiving feedback information; and
a controller, coupled to the phased array antenna and the receiver, wherein the controller adjusts an amplitude or a phase of output of an antenna unit of the phased array antenna according to the feedback information.

7. The antenna device according to claim 6, wherein
the radio frequency signal forms one of a first beam-forming signal and a second beam-forming signal, wherein
the feedback information indicates the one of the first beam-forming signal and the second beam-forming signal.

8. The antenna device according to claim 6, wherein
the feedback information further indicates a measurement result of the radio frequency signal of a terminal device, wherein
the controller adjusts the output of the antenna unit according to the measurement result.

9. The antenna device according to claim 1, wherein the phased array antenna comprises one of a monopole antenna, a dipole antenna, and a multi-polarized antenna.

10. A method for configuring an antenna device, comprising:
configuring a phased array antenna of the antenna device to emit a radio frequency signal; and
configuring a wave-shaping accessory of the antenna device to reflect or refract the radio frequency signal to form a beam.

11. The method according to claim 10, wherein the wave-shaping accessory comprises at least one reflector.

12. The method according to claim 11, wherein the antenna device comprises a parabolic antenna, and the at least one reflector comprises a main reflector and a sub-reflector, wherein the step of configuring the wave-shaping accessory of the antenna device to reflect or refract the radio frequency signal to form the beam comprises:
configuring the sub-reflector to reflect the radio frequency signal to the main reflector; and
configuring the main reflector to reflect the radio frequency signal to form the beam.

13. The method according to claim 10, wherein the wave-shaping accessory comprises a lens.

14. The method according to claim 13, wherein a material of the lens comprises a dielectric material.

15. The method according to claim 10, further comprising:
configuring a receiver of the antenna device to couple to the phased array antenna and receive feedback information; and
adjusting an amplitude or a phase of output of an antenna unit of the phased array antenna according to the feedback information.

16. The method according to claim 15, wherein
the radio frequency signal forms one of a first beam-forming signal and a second beam-forming signal, wherein
the feedback information indicates the one of the first beam-forming signal and the second beam-forming signal.

17. The method according to claim 16, wherein the feedback information further indicates a measurement result of the radio frequency signal of a terminal device, wherein the method further comprises:
adjusting the output of the antenna unit according to the measurement result.

18. The method according to claim 10, wherein the phased array antenna comprises one of a monopole antenna, dipole antenna, and a multi-polarized antenna.
